(19) United States
(12) Patent Application Publication
(10) Pub. No.: US 2014/0114984 A1
(43) Pub. Date: Apr. 24, 2014

(54) METHOD AND SYSTEM FOR USER AUTHENTICATION

(71) Applicant: WONGA TECHNOLOGY LIMITED, Dublin (IE)

(72) Inventors: Alexey Kadyrov, London (GB); Jonathan Galore, London (GB); Daniel Hegarty, London (GB); Larry Shapiro, London (GB)

(73) Assignee: WONGA TECHNOLOGY LIMITED, Dublin (IE)

(21) Appl. No.: 13/841,428

(22) Filed: Mar. 15, 2013

(30) Foreign Application Priority Data
Apr. 19, 2012 (GB) 1206927.4

(51) Int. Cl. G06F 17/30

(52) U.S. Cl. CPC G06F 17/30259
USPC 707/748

(57) ABSTRACT

A method and computer system for providing a measure of confidence of the identity of a user of a remote computer system. Information from the remote computer system about the purported identity of the user is received. A plurality of images of street scenes located within a geographical area of a neighbourhood surrounding a physical address associated with the user is collected along with the plurality of images of street scenes located outside of the geographical area. Signals are sent to the remote computer system allowing it to display the users of the streets scenes and asking the user to select those images which are in the geographical area. Information about the user's selection is received and a rating of confidence that the purported identify of the user is correct is made as a function of the user's selection.

### BACKGROUND OF THE INVENTION

This invention relates to methods and systems for authentication of users of online systems.

There are many known systems and methods for verifying or authenticating that a user of a device or online terminal is who they say they are and that they have authority to access the data or service they are requesting. An example of such a system includes the standard arrangement for providing a username and password, this information having been provided separately to the user. By providing this knowledge, the user indicates to the access system that they have appropriate authorisation. More sophisticated schemes include smartcard systems as used in online banking systems or conditional access television systems in which a smartcard stores encryption algorithms which may be used in conjunction with a personal identification number (PIN) so as to indicate to an online system that the user has possession of the independently provided smartcard and PIN which have been delivered separately to the user.

Systems such as those described above can be very secure, particularly the chip and PIN style of system. Accordingly, these are typically deployed in systems, which simply allow or deny access to data or services as a result of a log-in procedure involving the authentication step.

### SUMMARY OF THE INVENTION

We have appreciated that some types of system, particularly online systems, do not need security at such a high level as the chip and PIN approach. Indeed, some online systems need the ability to authenticate a user online without any independent channel of communication between the user and the online service other than by the online service itself. In addition, we have appreciated the need for speed of authentication for online systems.

The invention is defined in the claims to which reference is now directed.

An embodiment of the invention comprises a system for providing a measure of confidence of identity of a user of an online system. An online system may be any system by which a remote communication is made whether by wired communication, wireless, the internet or otherwise from a remote terminal or device to retrieve data or provide a service. An input is arranged to receive data relating to a specified individual including an address of the specified individual. This address data may be entered by a user at a point of using the service, or could be retrieved from some prior store.

An image data retrieval unit retrieves image data from a database and an image selection unit selects from the retrieved image data one or more images representing a geographical area in the vicinity of the specified address.

An image retrieval and presentation unit is arranged to retrieve the images relating to the selected data and to present the images to the user. An input is arranged to receive a selection made by a user indicating which image(s) relate to the address of the individual. In order to provide greater certainty, images that are not related to the address specified are also presented to the user so as to ensure that the user cannot simply guess which images correctly represent the geographical area specified by the address.

A confidence calculation unit receives the data relating to the selection made by the user, from which a measure of confidence is determined as to whether the user is actually the individual relating to the specified address. The confidence calculation unit may be part of the system, or separate functionality receiving an output from the system.

Using the embodiment of the invention, the system is able to provide a confidence measure using the fact that a user would be expected to recognize images taken in the vicinity of the address at which they live, or other address connected with the individual, without error and in a limited period of time. The confidence calculation may include measures such as number or amount of movement of an input device such as a mouse, number of clicks, and time taken to select the images, as well as, of course, whether or not the user correctly selected the images.

In this way, the output of the system may be more than a simple access/deny message, but rather is a measure of confidence that may be expressed as a scalar value such as a percentage or a vector value such as scores for each of a number of metrics such as time, number of clicks and image selections. Such a confidence measure may be used in subsequent processing in the online system to determine the extent to which access is given to data, services or other aspects of online systems.

### BRIEF DESCRIPTION OF THE DRAWINGS

The preferred embodiments of the invention will now be described in more detail by way of example with reference to the drawings, in which:

FIG. 1: is a schematic diagram of a system embodying the invention;

FIG. 2: is a diagram showing the relationship between the area that is used for the neighbourhood and for tiling;

FIG. 3: is a flow diagram showing the steps for image selection;

FIG. 4: shows the overall process for image metadata selection and image retrieval;

FIG. 5: shows the neighbourhood image selection processing in greater detail;

FIG. 6: shows yet further detail of the image selection process used for a specific user;

FIG. 7: shows extracting metadata about interesting locations in a tile using an API;

FIG. 8: shows a process used if insufficient images are found;

FIG. 9: shows a specific process for retrieving foil images;

FIG. 10: shows a diagram of a geographical area used in the image selection and foil selection process;

FIG. 11: shows an appropriate selection of images in relation to a geographical area;

FIG. 12: shows an inappropriate selection of images for a geographical area; and

FIG. 13: shows a user interface for selecting images.

### DETAILED DESCRIPTION OF THE PREFERRED EMBODIMENTS

The invention may be embodied in an online access system that seeks responses from a user prior to allowing access to data or services, whether then provided online or via some other route. The invention is particularly applicable to systems requiring a rapid measure of confidence that a user is the individual they claim to be, but without requiring any additional transactions outside of the online system. An online system may be any system with which a user remotely seeks to communicate by wired, wireless or other connection for the purpose of obtaining access to a service.

An embodiment of the invention provides a system such that, given a residential address for a user, one or more distinct local street images from the neighbourhood will be selected and representing the location specified by the address. If the user does live in the residential address provided, he/she would be expected to be able to recognize the image(s) within a certain time frame. In addition, one or more images from different areas will be selected and built into their own clusters, to act as “foil” or “filler” images. The resulting images, including the correct one(s), will then be shown to the user, who will need to select which image(s) he/she recognizes. By selecting the correct image(s), and hence evidencing familiarity with the local area, the user confirms that he/she is likely to be from the address provided.

Various parties, such as Google, have undertaken detailed mapping of city streets, with images provided from databases such as part of the Google Street View (GSV) service. There is increasing coverage of the cities that are mapped under this scheme, and the image data is available through an API, so it can be used for these purposes together with computer vision and machine learning techniques.

The request for user authentication may be made as part of the user's online usage, and must not delay this process unduly. Since a certain amount of time will be required for image retrieval and the image analysis, the call to this function should be made as early as possible so it can run in the background, and be ready once the user reaches the relevant section of their online use.

System Overview

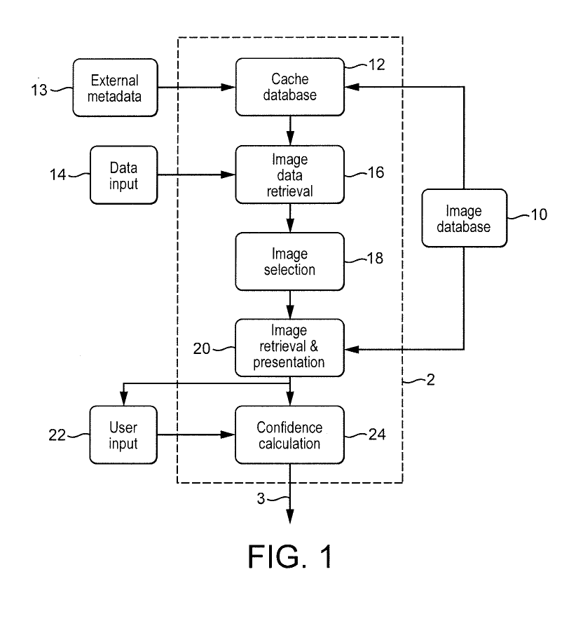

FIG. 1 is a diagram of the main functional components of a system preferably used in carrying out the invention. It is to be understood that each of these components may comprise separate hardware or software modules, some of which may be combined. The modules are described separately for ease of understanding.

The system 2 for providing a confidence measure is arranged to receive an input of data from a data input 14. The data input 14 may be a web browser or mobile device and may include retrieving data from other databases. Typically, the data that is input will be an address, post code or other geographical indication of the address at which the user of the system claims to live. An image data retrieval module 16 receives the address information and determines from the address information a geographical area from which images are to be retrieved. The image data retrieval module 16 then retrieves data from an image database 10 via a locally stored cache database 12. The data retrieved may be considered as metadata relating to locations and images, as will be described later.

The main implementation of the preferred embodiment is to use an external image database 10 such as provided by a third party, such as the Google Street View product. In this way, the authentication system 2 can consistently work with up-to-date image data. In addition, as an alternative or in combination, a cache database 12 is provided within the system. Each time a set of images and metadata are retrieved from the external image database 10, these may be additionally stored in the cache database 12 so that subsequent requests for images and metadata in the same geographical area may be retrieved from the cache database. Optionally, images and metadata could be periodically downloaded from the image database 10 to the cache database 12, so as to provide improved speed of access so that the image retrieval module 16 only requests images from the external image database 10 if they are unavailable from the cache database 12. The preferred approach, though, is to store image metadata in the cache database 12 and to retrieve the actual images direct from the image database 10.

Once data has been retrieved by the image data retrieval module 16, it is passed to an image selection module 18 to allow the precise images to be displayed to the user to be selected. The selection of images from the many images retrieved relating to geographical neighbourhood or area is a feature that provides accuracy to the system. Using a variety of heuristic approaches, and based on metadata, images are selected that should be easily identified by a user as having been taken within the neighbourhood of their address. The image selection process will be discussed later in greater detail.

An image retrieval and presentation module 20 retrieves the images and presents them to a user in such a way that the user must make a selection within a time frame to indicate that they recognize images taken in the neighbourhood of their address in contrast to dummy or “foil” images taken in a different geographical area.

In response to the presentation of images taken both in the neighbourhood of the user's address and from other geographical locations, the user may make an input at user input 22, typically a mouse, touchscreen or other input device, which provides input data to a confidence calculation module 24. The input data comprises the selection of which image(s) the user indicates as being taken in the neighbourhood of their address, and also includes other metrics taken from the user input device such as the number of movements of a mouse, or the way in which the user moves the mouse. In addition, timing information is provided by the image presentation module indicating the time taken by the user from presentation of the images to selection of the image. The confidence calculation module 24 then determines a measure of confidence from this data which is then provided at an output 3 of the system 2.

The components of the system will now be described in more detail in turn. However, for the avoidance of doubt, the functions provided by the retrieval, selection, presentation and calculation modules may be combined together as a single functional unit.

Image Database

The image database 10 may comprise a single database from an external provider or may comprise multiple databases from different providers or may be provided as an integral part of the system 2. The preferred approach is to use a single external image database 10.

The image database 10 and cache database 12 may have the same structure and contain similar data, with the cache database preferably holding a sub-set or all of the data from the image database that has been retrieved on previous occasions. The preferred embodiment though is for the cache database 12 to contain metadata relating to geographical locations and images with references to the images which are stored in the external image database 10.

The purpose of the data in the image database and cache database is to store images and metadata associated with those images as well as geographical metadata not directly related to a particular image. For ease of discussion, we will refer to metadata associated with an image (e.g., the location of the image) as a “point” and metadata associated with specific places of interest (e.g., a business) as “places”.

The metadata representing the geographic “point” at which each image has been captured and metadata relating to each image, such as tags indicating any categories of item within the image, will now be described.

An example row of database data in the cache database for one such point is given below.

| Field Name | Example |
|---|---|
| Image ID | ID123 |
| Position | 050 51.73; 001 18.78 |
| Category | Business |
| Direction | 012 |
| Links to other points | ID456 |

A point as shown above may be uniquely identified by the position data (here given as a latitude and longitude string) showing the geographic position at which the associated image(s) were taken. A point may be associated with a single image or multiple images. Preferably, each point is associated with an image providing a view, preferably a 360 degree view, taken at the specified position, herein referred to as “panos”. In the example of the provider Google, the data for each point also includes the direction of travel of the camera at the time the image was taken in degrees from true north. The image database includes the metadata for each point and additionally stores the images themselves.

| Field Name | Example |
|---|---|
| Image ID | ID123 |
| Image data | (JPEG data) |
| Position | 050 51.73; 001 18.78 |
| Category | Business |
| Direction | 012 |
| Links to other points | ID456 |

The data for a “point” is supplemented by the following additional fields, which may be stored in the cache database or in the image database.

| Field Name | Example |
|---|---|
| Rating | 5 |
| Cluster member | 10123 |

The separation of the metadata relating to each image in the cache database and the same metadata relating to each image and the image itself stored in the image database is a particularly convenient one. By storing the metadata within the system 2 in the cache database 12, this can be rapidly retrieved and analysed when a request is received. When the images are to be retrieved, though, these can be retrieved from the external image database 10 (which may comprise a single database or multiple sources). This allows the maintenance of the image database to be outsourced to one or more third parties. With this database arrangement, the image database could simply hold images and identify off those images, with all remaining metadata stored within the cache database.

The metadata relating to “places” will now be described. An example data structure is:

| Field Name | Example |
|---|---|
| Position | 050 51.73; 001 18.78 |
| Category | Business |
| Name | ABC Restaurant |

The place metadata provides information indicating that there is something of interest at a specified location. The place metadata includes a name, a category and the particular position of the thing of interest. A key example is a business residence, such as a restaurant or the like.

The place metadata may be provided by the external image database 10 and may also be supplemented with additional information upon retrieval to the cache database 12. A particular example of this is to derive additional category information from the place name. In the example above, the name indicates that an additional category of “restaurant” would be appropriate for the place.

Image Data Retrieval

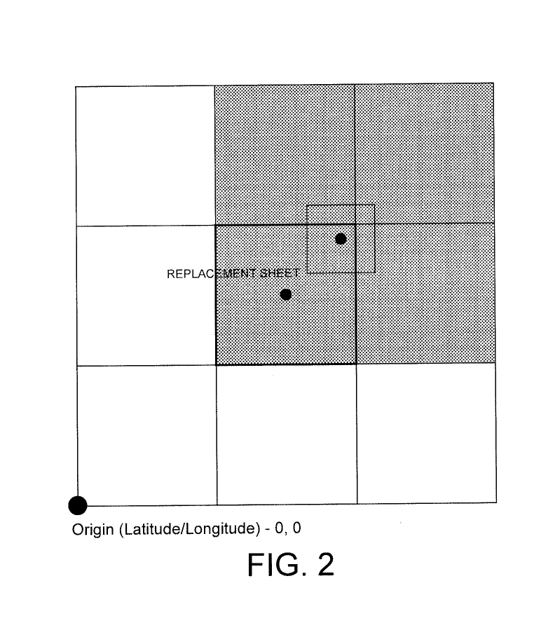

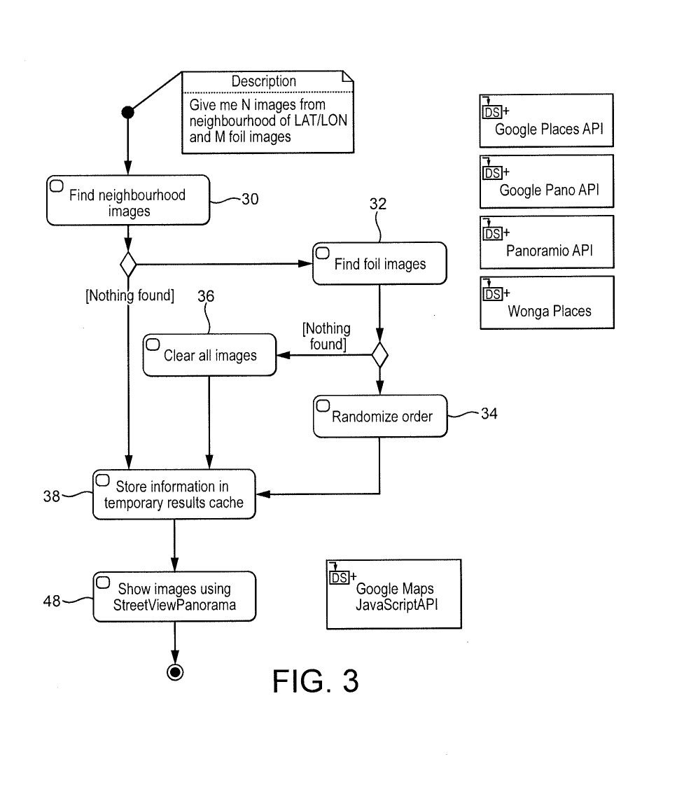

The functions of the image data retrieval module 16 will be initially described with reference to the diagram of geographical tiling of FIG. 2 and will then be further described with reference to the flow diagrams of FIGS. 3 to 9.

The function of the image data retrieve module 16 in conjunction with the image selection module 18 is to retrieve the metadata relating to potential images to be shown, to analyse the metadata and to select from a potentially large number of candidate images the one or more images relating to the address supplied by a user and one or more alternative “foil” images that are not related to the address supplied by the user. On receipt of address data, this is converted to a latitude and longitude value (LAT/LNG). In addition, the image retrieval module 16 determines an appropriate distance from the LAT/LNG geographical location defining an area for which the images are to be retrieved. These parameters are passed to the cache database and metadata for all images within the area so defined are retrieved.

In the event that metadata relating to images for the particular geographical location is not available in the cache database 12, this data is retrieved from the image database 10. In a sense, the initial retrieval of metadata is performed through the cache database.

The image and position related metadata may include a variety of tags, as already described, describing the name of any building, business or other feature shown within the image, the category of any business shown within the image or other such metadata. A particular example of metadata is Google “Places” as already noted, which are separate items of metadata providing information about location and some textual information associated with the location, like name and category. These may be created centrally for or by a community of users. Metadata related to images can also include data relating to how the image was captured such as the field of view, elevation and compass direction, as well as information such as depth of view within the image.

In order to provide an appropriate mechanism for caching metadata in a manner that may be easily refreshed, queried and maintained, the geographical area represented by the data is logically divided into separate “tiles”; each tile representing an angular latitude and longitude. A set of such tiles is shown in the diagram of FIG. 2, which illustrates the area used for neighbourhood images (the smaller off center) and tiling. The tiles with shading are the tiles which will be used to get information and need to be cached. Preferably, the tile size in angular degrees for example at Dublin's latitude (53.28) equates to approximately 800 by 1300 metres. While shown as a square, the tiles are actually a projection of an angular view of the approximately spherical surface of the Earth and so naturally each tile will actually have a shorter vertical dimension at the end of the tile nearer the Equator than at the end of the tile further away from the Equator (on the Equator it should be an almost perfect square). The tile arrangement is chosen to have the origin at a latitude and longitude of 0,0. The data stored in the cache database is linked to a given tile. For example, in a SQL database implementation, the database may have three tables—for tiles, points, and places where point and place tables will have a primary-foreign key relationship with tile table. Alternatively, the related points and places will be directly saved as part of the tile graph. The implementation supports both scenarios. When any data in a given tile is found to be obsolete, then the data for the entire tile is removed and refreshed at an appropriate time. The refreshing of tiles could be carried out when a request is made to that tile; but more likely, for locations that are frequently used, tiles will be periodically updated in the cache database.

Advantages of using this tile-based approach to caching data include that it allows simple management of obsolete data, provides a convenient mechanism for managing the amount of data to be retrieved in any given cache refresh and allows for any limits in the amount of data that an external provider can provide in any given request or set of requests. It also simplifies the process of checking when a portion of the cache should be refreshed.

Referring to FIG. 2, the first step in retrieving image data is to resolve the address of a geographical location as indicated by data received at the data input 14 direct from a user or retrieved from another source. The address may be input in any convenient format, but typically a postcode is used which may be converted by the image data retrieval process to a geographical location in latitude and longitude as shown by the point in the smaller square of FIG. 2. A boundary size, here chosen to be an angular degree equating to approximately 600 metres, defines an approximate square boundary that would be considered for image selection.

The next step of image data retrieval is to determine which tile of the tile arrangement the location belongs to. In the example of FIG. 2, the small boundary square (the relevant geographical area of the user's neighbourhood in this example) intersects four tiles but the geographical location shown by the dot within the small square is within the central tile shown in the figure and so the location is deemed to belong to the central tile. All tiles intersecting the boundary, here the top four right hand tiles, are of relevance and so will be used to determine if enough data is cached or if data for these tiles should be retrieved.

Image Selection

The image selection module 18 operates processes to reduce the number of candidate images to an appropriate selection of images for presentation to a user. An overview of the image selection process will first be described and is based on the content of the images, the metadata accompanying the images, user data either input at the input 14 or retrieved from elsewhere, as well as further data within the image selection module used to categorize the user based on demographic information.

The purpose of the image selection process is to select images of items within the neighbourhood that are likely to be easily identified by a user and also which differ sufficiently from images taken from an area outside of the neighbourhood, so as to provide a high probability that the user can quickly select the correct images representing the neighbourhood in which they live. The detailed image selection process is describe later and uses metadata to establish the images that are likely to be recognisable to the user using metadata such as keywords, categories and derived routes between places in the neighbourhood.

Items that would be of local interest may, by way of example, include:
Buildings (e.g. a church, school, shopping center, bridge, court, office blocks, cinema, garage, hotel, supermarket, etc.)
Shops (e.g. unique restaurants/retail shops)
Gardens
Railway/tube stations
Streets/traffic/High Street scenes

An extension to this selection process, that is possible but not preferred, is to further discriminate scenes from the images retrieved based on image content, e.g. not images that could be from anywhere in the land, such as common brand shops (e.g. local Starbucks) or typical housing stock (e.g. pebble dashed semi-detached houses in Britain). Images should also be at street level height where users would be most likely to have viewed that aspect (e.g. high level features or satellite imagery would not be suitable). Given a local LAT/LNG coordinate, there are a large number of images that can potentially be shown to a user. The selection of candidate images can be reduced by standard image processing techniques, e.g. suitable framing, removal of “bland” images and detection of key building types, as discussed above. However, further culling of the image space may be required to reduce down to a manageable number of images. For the test to be meaningful there needs to be a context to the images shown to the particular user. Options for such further image content processing are described later.

The preferred selection process starts with all images that have been retrieved for the particular neighbourhood, reduces the images to those likely to represent interesting local street features, and then further reduces the images presented based on user demographics. One step in the process is to identify clusters of images, to retrieve these and optionally to analyse them for similarity using any known image similarity algorithm. Clustering of images suggests an interesting location, however, only one of the images in the cluster of similar images will be selected. Another process is to select images having particularly key words in the metadata, in particular those that are already tagged as representing businesses in the area. A further process is to identify images taken along main roads.

One of the main processes used in image selection is the use of demographic information based on data retrieved in relation to the individual whose address has been provided. Such demographic data may include age, occupation, education, income, marital status, number of children and number of children of school age. Using this information improves the selection of images by enabling images appropriate to users with school age children (images of schools), images appropriate by age (local night clubs vs. local bowling clubs), income (restaurants or fish & chip shops) and so on to be selected. Each of the processes may be run multiple times to refine the image selection and processes may also be run in a variety of orders.

A further selection process is to use routing information as a mechanism for determining the roads most likely used by the individual from the address provided and, therefore, which images are most likely to be easily recognisable.

By routing information we mean the path in which the potential geographical locations from which the images were taken are traversed. Such routing information can be based on some general heuristics that apply to all users, and some specific calculations that apply to a specific user only (based on other data held about that user). For example, people living in a given area will most likely know their local: High Street, busy roads (especially high footfall areas), ATM machine(s), department store(s)/shopping mall(s), hospital, movie theatre(s), Post Office, restaurants, supermarket (known as “nearest milk”) and perhaps also know their local church (if the building is distinctive), fire station, pharmacy(ies), police station, stadium, university or zoo.

More specific routing information may be used, for example people living in an area will most likely know their local: job center if they are unemployed, library(ies) if they have children, petrol station(s) if they drive, pubs if they are young, school(s) if they have children and tube/train station(s) if they use public transport to get to work. People who have cars and drive will see a different aspect of the area than those that walk (e.g. different viewing angles).

The following demographic data collected during the authentication process can assist in determining the likely routes that the applicant will traverse: date of birth (used as part of likely establishments visited such as type of restaurants/pubs, gender (types of shops visited), number of dependants (can guess ages based on DOB and so whether likely to attend primary/secondary schools), vehicle number (whether drive or walk and which routes), employment status (whether they go to work and, if so, where the work address is/likely means of transport/commute route).

Image Retrieval and Presentation

The image retrieval and presentation module retrieves the selected images for presentation. As part of the image retrieval and presentation, the nature of the images themselves may be analysed in various ways. As a first example, the images may be analysed for similarity of the images using various known similarity algorithms. As a second example, the images may be analysed for memorability and the rating of the images altered accordingly. Thirdly, images may be selected based in distinctiveness. These three approaches are known to the skilled person and will not be described further. Finally, when no further image analysis assists, then the top images are selected, using some random selection if needed.

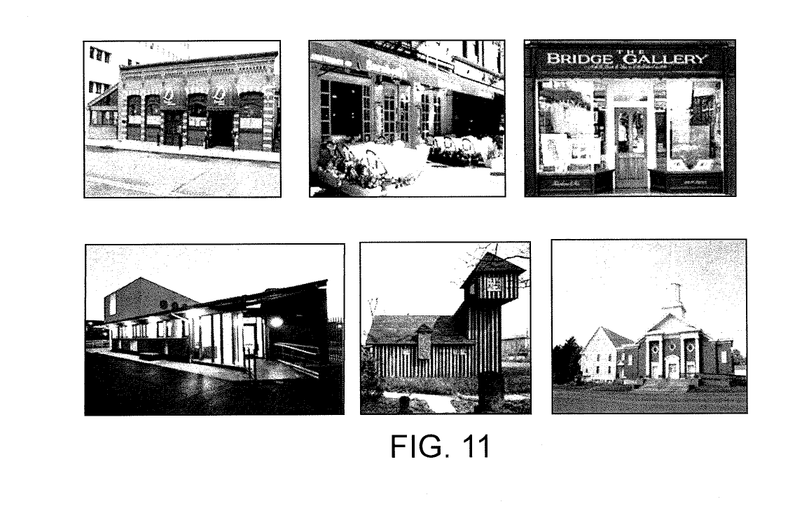

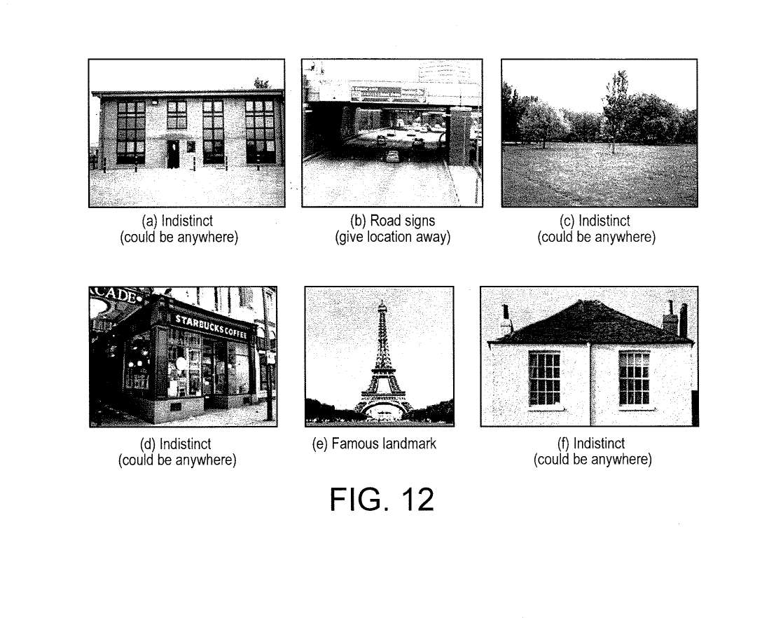

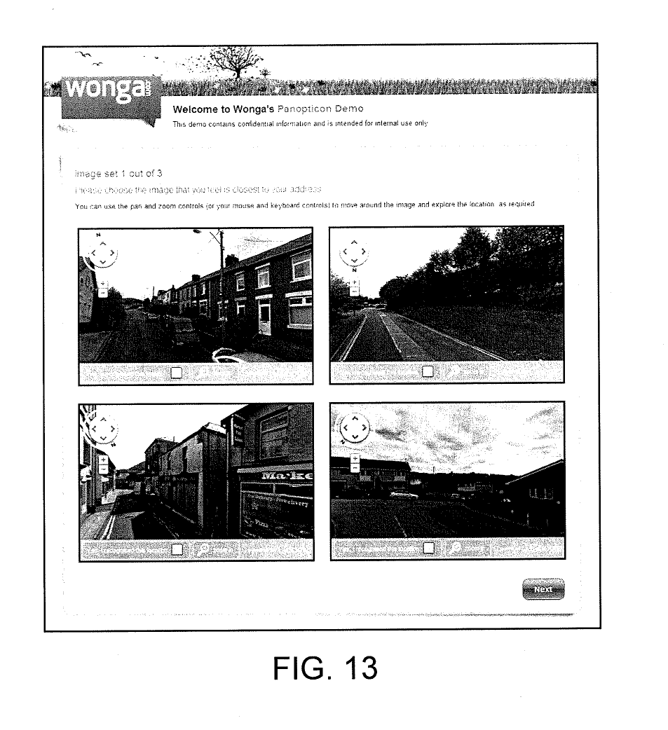

The manner in which images are presented to the user can have a bearing on the accuracy of the confidence calculation. An example of images presented to a user is shown in FIGS. 11 and 12, and an example of the manner in which the images can be presented is shown in FIG. 13. The preferred interface will allow dynamic control of the “pano” image so that the user can rotate and/ or zoom the image.

A selection of images deemed suitable and unsuitable are shown in FIG. 11 and FIG. 12 respectively. Naturally, all images should be blur free and of a suitable viewing quality.

It is also vital to ensure that none of the images (whether in the correct cluster or the foil cluster) contain clues about their location (which would skew the guessability aspect), for example local area signs which would easily give the location away. One way of achieving this may be to require that all text in the image be automatically obscured (e.g. blurred).

The image quality selection algorithms that are part of the selection and presentation steps are arranged to overcome such problems.

Confidence Calculation

The selection of the correct image(s) is a significant part of establishing a measure of confidence as to the identity of a given user. However, if the system uses several images in a multiple choice scenario a potential fraudster only really needs to find one image that matches. In order to provide a useful confidence measure, the system preferably uses a mixture of response time, image selection and (optionally) clickstream data. If the algorithm is tuned correctly, a user should spot his/her neighbourhood almost instantaneously. The system can also track mouse co-ordinates, tab switches or unnatural pauses, which may be associated with the use of another computer and assign confidence intervals taking these into consideration.

Various algorithms may be used. The preferred is a percentage of correctly identified images by the user (e.g. 1 out of 3), with a simple cut off (e.g. at least 65% based on 3 sets of images). An output may be asserted as confirmed or denied based on the cutoff.

An additional variant is to measure the dwell time spent by the user on each page before making his/her selection, and to scale down the value of the correct answer fractionally based on the amount of time taken to choose it (the longer taken, the less value it has, since the more likely the user could have had help from other sources, e.g. looking up the images in another browser). An example formula here might be:

$$Score ( \% ) = 100 \times \frac{{\sum }_{i = 1}^{n} {C}_{i}}{n}$$

where
n=the number of screens shown (3 for us currently)
Cᵢ=0 if the answer was incorrect on screen i
Cᵢ=1/(tᵢ/t₀) if the answer was chosen correctly on screen i in time tᵢ (seconds)

with Cᵢ representing a confidence score where
t₀=3 seconds (say—representing a quick time to select the image)

and the Score is subject to a general cut off (e.g. 70%).

Applications

The methods and systems described may be used in a variety of authentication arrangements. For example, local community web sites may wish to restrict use primarily to people that actually live in a particular geographical area. Alternatively the methods and systems may be used to allow credit lending agencies to accurately identify prospective borrowers (“applicants”) prior to advancing them loans, which reduces their exposure to fraud/identity theft.

Detailed Processes

The processes operated by the system of FIG. 1 will now be described in greater detail in relation to FIGS. 3 to 9.

An overview of the process for retrieving and selecting images is shown in FIG. 3. The purpose is to retrieve N images from the neighbourhood surrounding the latitude and longitude coordinates and M foil images. First, at step 30, the neighbourhood image points are selected using the tile approach described in FIG. 2. Next, the foil image points are selected that fall outside the neighbourhood area as will be described later, at step 32. The order of the foil images is randomised at step 34. If no images are found for the foil images then a repeated process is run to find foil images as will be described later and the image selection is clear at step 36. Lastly, at step 38, the neighbourhood and foil images are stored in a temporary cache.

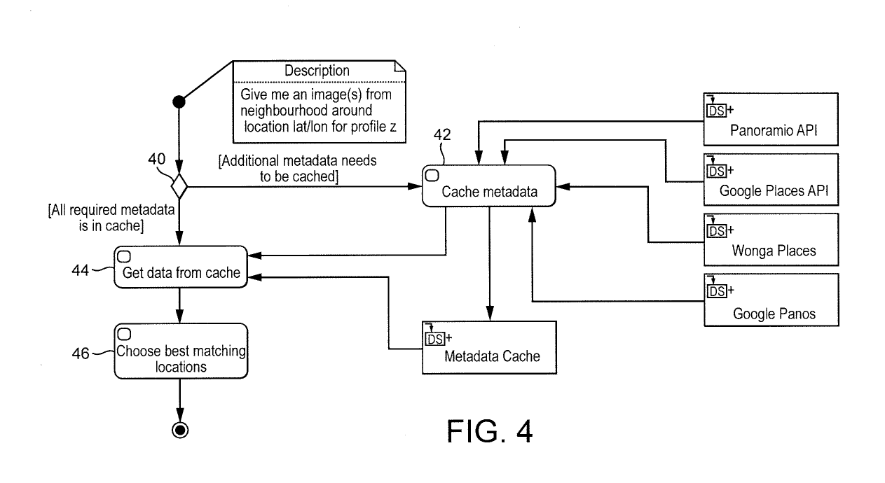

The process for retrieving the neighbourhood images is shown in greater detail in FIG. 4. The purpose of the process is to retrieve a given number of images near the latitude and longitude location specified for a given profile of the person using the online system.

On receiving the latitude and longitude location, the process first determines whether there is data for the given geographical tile at decision step 40 already held within the cache database. If so, the metadata relating to the points within the appropriate tiles is retrieved from cache at retrieval step 44. If the data is not within the cache and additional metadata needs to be cached, then a cache retrieval process 42 is run to populate the point metadata from one or more internal or external databases such as Google places, Google panoramas or additional metadata designed specifically for the system, here shown as Wonga places. The metadata retrieved from the various sources is then populated into the metadata cache. Once all metadata is available, a selection step 46 is executed to choose the best matching points and lastly, at step 48 (FIG. 3), the images themselves are retrieved for display, for example using the street view panorama functionality available through Google maps API.

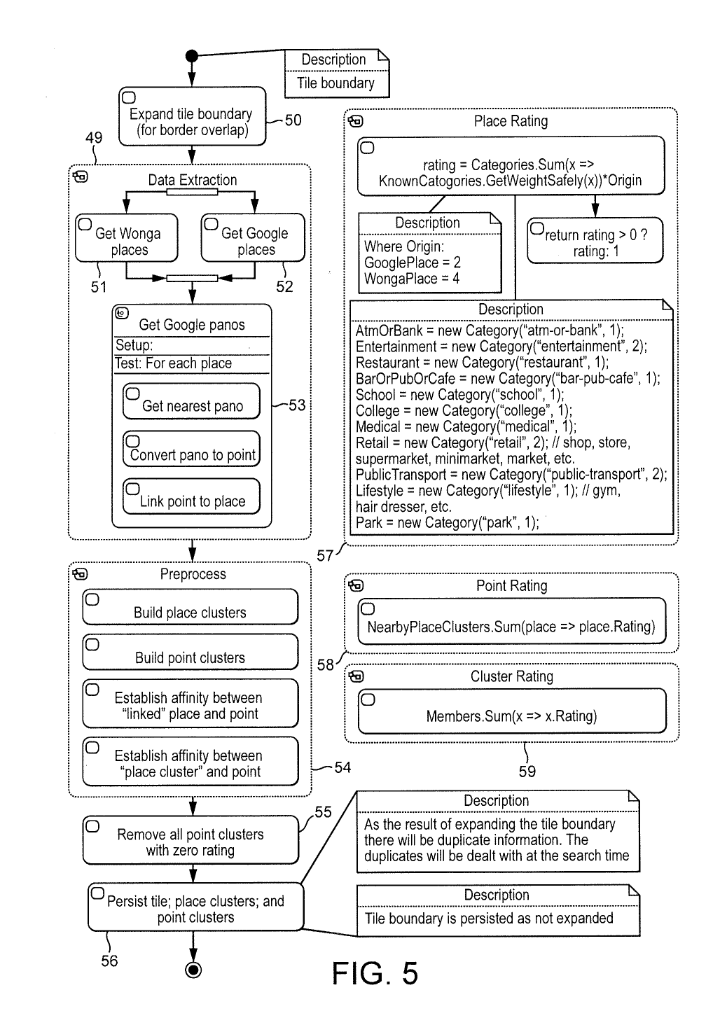

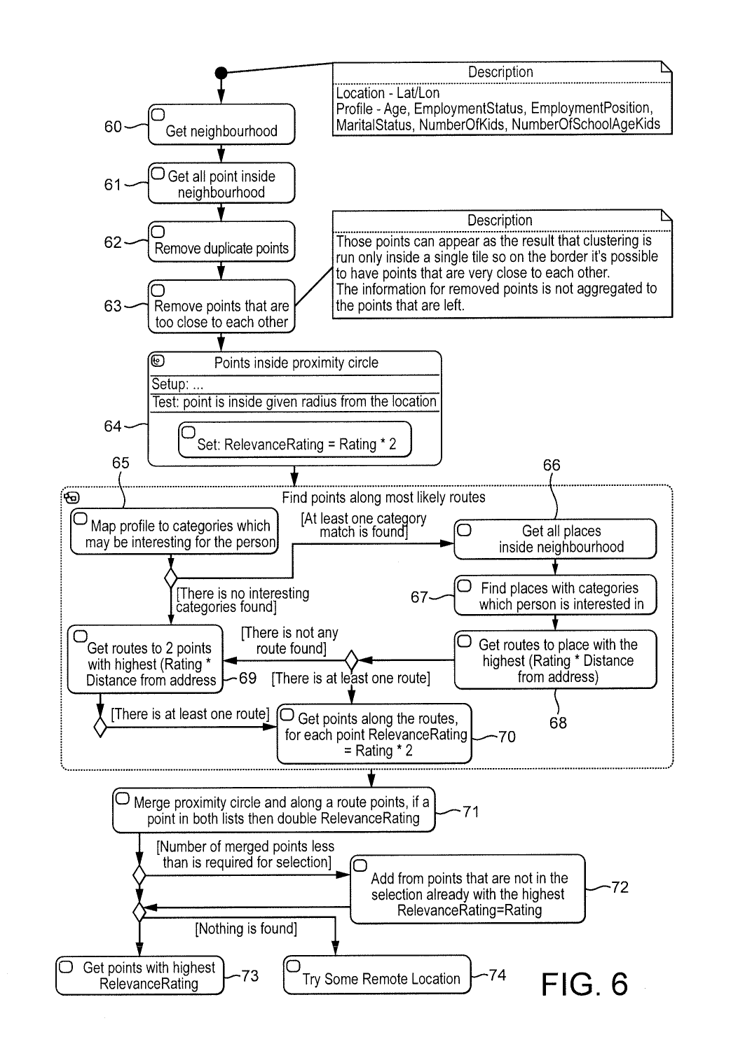

The inventors appreciated the need for an intelligent and efficient process for reducing the potentially very large number of images associated with geographical points within a given neighbourhood which could be presented to a user. Accordingly, the image selection module 18 provides a detailed image selection process which is described in relation to FIGS. 5 and 6. The process shown in FIG. 5 reduces the potential number of candidate image points by considering metadata relating to places of interest as stored within the databases. The process in FIG. 6 then goes further and selects a more tailored set of image points appropriate to the given user of the online system using a profile of the user.

The selection process for reducing the number of candidate image points shown in FIG. 5 comprises a data extraction stage 49, as shown in the top left of the figure and a preprocessing stage 54, show in the bottom left of the figure as well as a place rating routine 57, a point rating routine 58 and a cluster rating routine 59. In broad terms, the operation of these processes is to consider the place metadata identifying geographical locations of interest, reduce the number of such places by using ratings giving a level of interest of each such place, clustering the places and clustering image points that are near the clusters or places, thereby allowing image points to be excluded that are not in the vicinity of places of interest. In a first step of the process, the boundary of a tile is expanded to provide some overlap with neighbouring tiles at step 50. The metadata for places is then extracted from the cache database or external database as previously described to obtain third party place metadata, here shown as Google places at step 52 or system generated place metadata, here shown as Wonga places at step 51. The steps so far have retrieved the place metadata. The next step 53 obtains the image point metadata and involves a routine for each place of obtaining the nearest points metadata and the associated image (here described as a “pano” being short for panographic or panoramic image) and then linking the places to their nearest image points.

The next process, the preprocess 54, groups together points and places that are geographically near using a clustering process by first clustering together groups of places, then clustering points, then for each point clustered determine the point that is geographically nearest the center of the cluster of points and establishing an affinity between the point clustered denoted by that geographically central point and a corresponding place.

At two final steps, a removal step 55 and an output step 56, the point clusters that have a zero rating because they are not associated with any places having a place rating are removed, thereby leaving clusters of points as candidates that are likely to have images that are of interest.

The place rating process 57 provides for each place a process for calculating a rating, a variety of such rating calculations are possible, but the preferred calculation is to sum the number of categories a place may belong to and add one. As shown by the logic description for the place rating, the metadata includes categories and for each category a value may be assigned to provide an additional rating. In this manner, categories such as restaurants, schools and banks may have a value of 1. Entertainment places and retail places may have a value of 2 and so on. In addition, for the finding of categories, the name of the place may be parsed looking for key words, so as to categorize the places in an appropriate category. In the examplary logic, the words shop, store, supermarket, minimarket and market are all parsed and determined to be retail places and given a weighting value of 2. As a result, using both predefined categories and categories derived by parsing place names, a total weighting may be given to each place.

The point rating process 58 ascribes to each point a rating based on the nearby clusters. As shown by the logic in process 58, the rating of point is the sum of the ratings for placing places within the nearest cluster of places.

The last process shown in FIG. 5 is a cluster rating process 59 which sums the ratings of the members of clusters to give a total cluster rating value. It is these values that are used later in the process to rank the potential points for which images may be retrieved in an order of priority. It is also these ratings that are used in step 55 to remove those points that have a zero rating. If, at the end of the process of FIG. 5, there are no points with a rating more than zero, there would be no candidates and so a process of expanding the geographical area would be run as described later. The clustering process may use a variety of parameters, but the typical options are that for each point, all points within a geographical distance of 30 metres are deemed to be within a cluster, such that any one point for each cluster is retained and the rating of the representative single point for the cluster is the sum of the ratings of all of the points within the cluster. The process for then selecting the most appropriate images to show to a given user is explained in greater detail in FIG. 6. At the point of entering the online system, the user will indicate their identity in some way either by providing details of the point of entry or by causing previously provided data to be recalled. In either case, used details may be retrieved from which a “profile” of the user may be determined. The profile may comprise certain fields of information, such as age, employment status, employment position, marital status, number of kids, number of school age children and other such generic profile information which can be used in combination with information retrieved on points and places. The first step 60 of retrieving the neighbourhood and second step 61 of getting more points inside the neighbourhood are as described in relation to FIG. 5. These are the retrieval steps for the points related to the geographical tiles surrounding the latitudinal and longitudinal location determined for the address of the user. At step 62, duplicate points are removed. Such duplicate points may arise because of the overlap between tiles. At step 63, points that are too close to each other are also analysed and one removed. These points that are too close can appear as a result of the clustering process that is run within each tile so that on the border between tiles it is possible to have points that are very close to each other. The information for points that are removed is simply removed from consideration and not aggregated to points that are left.

At a proximity step 64, the points within a proximity circle of the center of the tile containing the input geographical point are determined and the rating of those points is enhanced so as to give a greater weight to points closer to the specified address than those further away. The preferred weighting is to double the rating of such points.

A process for establishing likely routes traversed by the user of the system in their day-to-day life is determined at steps 65 through 70 so as to allow a further weighting to be given to points along such routes.

To find points along likely routes, a first step 62 in the process is to map profile of the user to the categories that are likely to be of interest to that profile. If at least one such category match is found, then all places in the neighbourhood are retrieved at step 66 and at step 67 those places that have a category matching the profile are determined at 67. The routes to one such place that has the highest rating multiplied by the distance from the original address is determined at step 68. If one such route with a highest rating is found, then the points along such a route are analysed and for each point the relevance rating for that point is multiplied by two so as to enhance the weighting of all points along the route at step 70. If there is not one single such route then at step 69, as a fallback step, routes to two points with a highest rating times distance from address are determined and the top one selected.

Lastly, to give a further weighting to points, at step 71, points that are both within a proximity circle as already described and also along the route as found by the process above have their relevance rating doubled.

The outcome of the weighting process for the points is that points that are both within a proximity and along a selected likely route are given the highest weighting. All the points are then arranged in order of their relevance rating and the top ones selected for presentation of their accompanying image.

In the event that there are no points found having any places of interest nearby by the process described, then a fallback step 74 is executed to try a different remote location. If points are found, but insufficient points returned as a result of the process, then additional points are taken that are not in the selection already having the highest relevance rating at step 72.

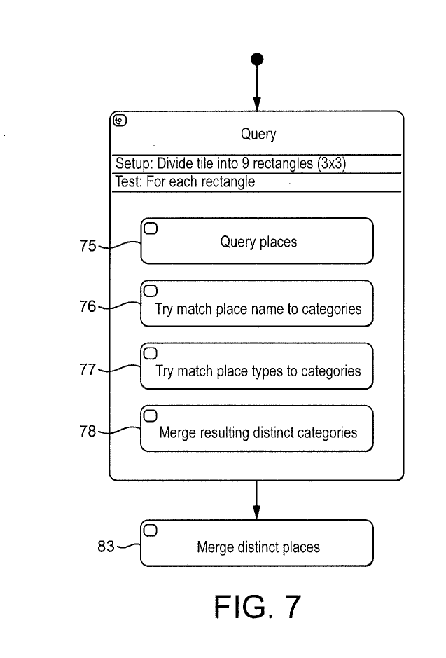

FIG. 7 describes an approach to extracting information about interesting locations in a tile using an API. In this example, the API returns up to 20 places only per request. In order to increase number of places, we break down the original tile into 9 sub tiles and send separate requests for each. As a result or the way the API is organized we are actually requesting information about 9 overlapping circles so the need for the last step in order to remove duplicates. At steps 75 to 78, places are queried, place names parsed and matched to categories, place “types” matched to categories and the distinct categories merged for each of 9 sub tiles. Lastly, the distinct places remaining are merged. This allows up to 180 places (9×20) to be retrieved for each tile.

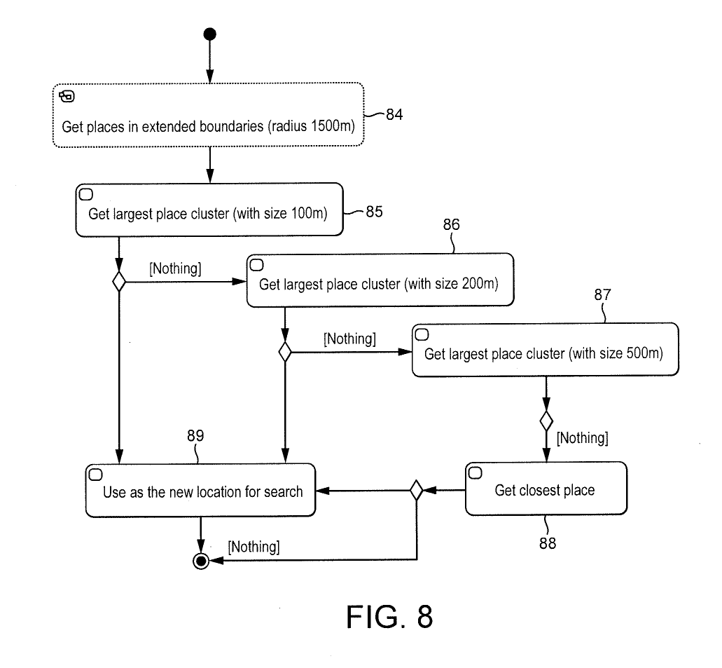

In order for the process of finding appropriate points to be universally applicable, a fallback process as shown in FIG. 8 operates in the event that no appropriate points are found due to, for example, the geographical sparseness of a given location. In rural areas, for example, there may be no particular places of interest within the external or internal databases and so there will be a need to look to the nearest urban area or a wider geographical area in which places of interest may be found. Accordingly, in the event that no points are returned by the process so far, at step 84, the boundary for getting places is extended (for example to a radius of 1500 metres) and then at step 85 the largest cluster found within such a boundary is determined as this indicates a likely geographical area with many places of interest. If no such largest place cluster is found of size 100 metres or less, then the place cluster size is increased in steps to 200 metres at step 86 and 500 metres at step 87 and if still no places are found then simply the closest place of interest is used as the location for a new search at step 89. In essence, this approach looks for clusters of places within a geographical limit as the location for a new initial starting geographical location to put into the process for selecting points already described.

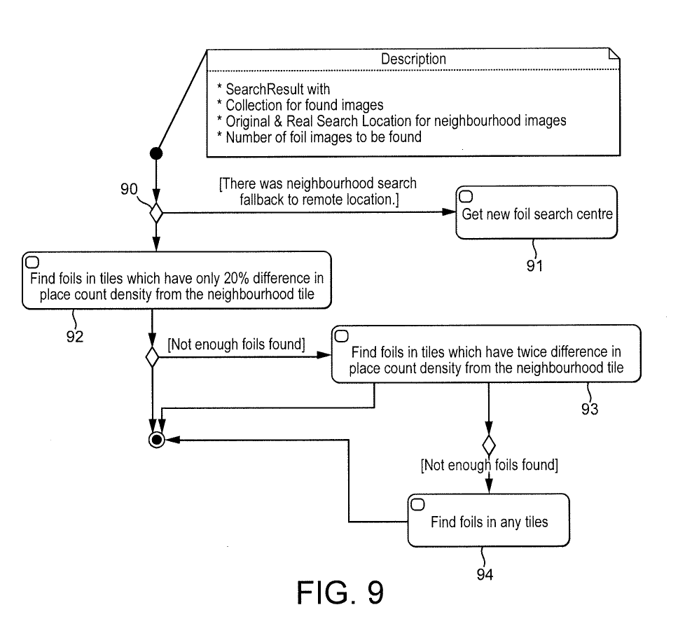

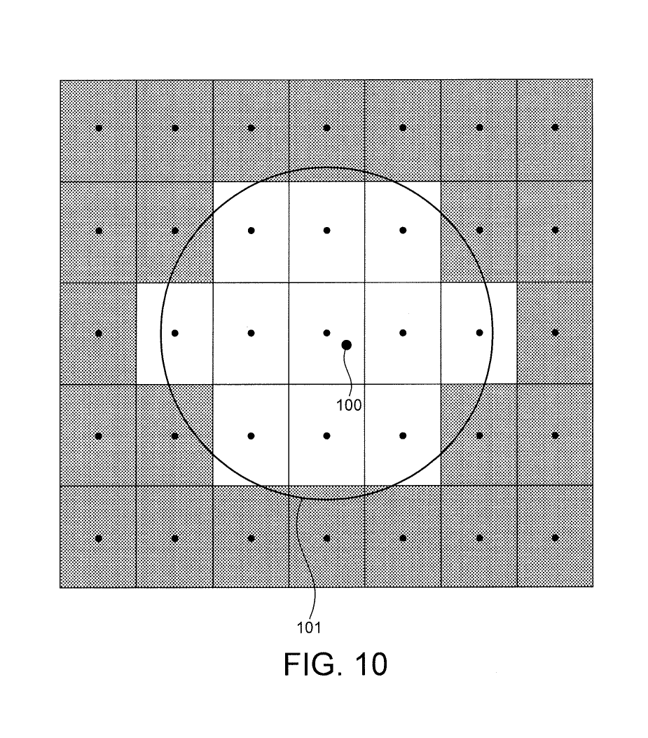

The process for selecting points thus far described is for selecting those points that have images that best represent a neighbourhood of the user. In addition, though, a number of dummy or foil images are needed to present to the user. For this purpose, a foil image selection process as shown in FIG. 9 is executed. The inputs to this process include the original location used and any alternative search location if used to find the neighbourhood images and the number of foil images to be found. If there was a fallback to a remote location used as described in FIG. 8, then add decision step 90, which is used as the location for the input to the foil search process at step 91. Otherwise, if the original location was used, then foil process step 92 finds points in tiles within the original search which have only a 20% difference in the place count density from tiles in the neighbourhood search. Referring again to FIG. 10, those tiles within the vicinity of the original search shown in the lighter colour intercepting the radius of the circle are those in the neighbourhood tiles, and the tiles outside of that circle but within the outer square are non neighbourhood tiles. The comparison is thus between tiles in the neighbourhood and tiles outside the neighbourhood and the points selected are those within a tile having a similar place count density. The purpose of this approach is to ensure that similar types of areas are used in the foil selection mechanism. For example, an urban area will have a certain place count density in contrast to a rural area which will have a lower place count density. If this step does not produce enough foil images then the tolerance of place count density may be varied, for example at step 93 to look for foils and tiles that have twice the difference in place count density from the neighbourhood tiles. If still not enough foil images are found, then foils may be looked at in any tiles at step 94.

The process for selecting the foil images is best understood with reference to FIG. 10. As can be seen, the center of the tile in which the address is located in is used as the foils search center. An outer boundary 10 km on a side is drawn, an inner exclusion circle 101 (with radius 2.5 km) is drawn. All tiles whose centers are inside the outer boundary are but outside the exclusion circle are considered for foils search. An optional parameter specifies how many images should be taken from a suitable tile (currently it's 2 which means that in order to get 9 foils we would need to check at least 5 tiles). The points with the highest rating (as discussed above for the main images selection) are retrieved. Other ways of selecting foil images are possible and would be within the scope of an embodiment.

1. A method of providing a measure of confidence of the identity of a user of remote computer system who desires to gain entry to certain functions of a central computer system, the method comprising:
the central computer system;
receiving information from the remote computer system about the purported identity of the user;
selecting a plurality of images of street scenes located within a geographical area of a neighbourhood surrounding a physical address associated with the user and a plurality of images of street scenes located outside of the geographical area;
sending signals to the remote computer system allowing it to display the images of the street scenes and asking the user to select those of the displayed images which are in the geographical area;
receiving information about the user's selection; and
rating the confidence that the purported identity of the user is correct as a function of the user's selection.

2. The method of claim 1, wherein the central computer system also receives information from the remote computer system about the address associated with the user.

3. The method of claim 1, wherein the central computer system receives information from the remote computer system about the purported identity of the user when the user attempts to gain access to certain functions of the central computer system.

4. The method of claim 3, wherein the information about the purported identity of the user is a user name and password.

5. The method of claim 1, wherein the central computer system comprises one or more servers connected to the Internet.

6. The method of claim 1, wherein the remote computer system is a desk top computer, a personal computer, a tablet computer or a smart phone.

7. The method of claim 1, wherein the plurality of images of street scenes are selected by:
determining the geographical area of the neighbourhood as a function of the address associated with the user;
selecting a subset of images of street scenes from a larger set of images of street scenes located within the geographical area; and
selecting a subset of images of street scenes from a larger set of images of street scenes located outside of the geographical area.

8. The method of claim 1, wherein the selection of images by the central computer system is made as a function of the demographics of the user.

9. The method of claim 8, wherein the demographics of the user are stored in a memory of the central computer system and are retrieved by the central computer system in response to receipt of information about the purported identity of the user.

10. The method of claim 8, wherein the demographics include the occupation of the user.

11. The method of claim 8, wherein the demographics include the age of the user.

12. The method of claim 8, wherein the demographics include the income of the user.

13. The method of claim 8, wherein the demographics include the marital status of the user.

14. The method of claim 8, wherein the demographics include the number of children of the user.

15. The method of claim 8, wherein the demographics include the employment status of the user.

16. The method of claim 1, wherein the images of street scenes located within the geographical area are selected to avoid images of retail shops having standard exteriors.

17. The method of claim 1, wherein the images of street scenes located within the geographical area are selected to avoid images of chain retail stores.

18. The method of claim 1, wherein the images of street scenes located within the geographical area are selected to avoid images showing writing indicative of the location of the image.

19. The method of claim 1, wherein the presence of businesses in the image makes it more likely that it will be selected.

20. The method of claim 1, wherein the images selected have metadata associated therewith and the selection of the images is made as a function of such metadata.

21. The method of claim 20, wherein the metadata of the images are stored at the central computer system and the images themselves are stored in a third party computer system which is not maintained by the party who maintains the central computer system.

22. The method of claim 1, further comprising the central computer system receiving information from the remote computer system relating to the manner in which the user selects the images and the central computer system rates the confidence that the purported identity of the user is correct as a function of the manner in which the user selects the images.

23. The method of claim 1, wherein the rating of confidence is determined as a function of the number of correct images selected.

24. The method of claim 21, wherein the rating of confidence is determined as function of other information received by the central computer system from the remote computer system and relating to the manner in which the user made the selection.

25. The method of claim 22, wherein the other information includes the time taken for the user to select the images.

26. The method of claim 22, wherein the other information includes click stream data received by the central computer system from the remote computer system.

27. The method of claim 22, wherein the other information includes information received by the central computer system from the remote computer system concerning the dwell time between selections of images by the user.

28. The method of claim 1, wherein the images within the geographical area are selected as a function of the distance of the location where the image was taken from the address associated with the user.

29. A central computer system comprising one or more processors, one or more memories and one or more programs stored in one or more of the memories for execution by one or more of the processors, the system:
receiving information from a remote computer system about the purported identity of the user of the remote computer system who would like access to certain functions of the central computer system;
selecting a plurality of images of street scenes located within a geographical area of a neighbourhood surrounding a physical address associated with the user and a plurality of images of street scenes located outside of the geographical area;
sending signals to the remote computer system allowing it to display the images of the street scenes and asking the user to select those of the displayed images which are in the geographical area;
receiving information about the user's selection; and
rating the confidence that the purported identity of the user is correct as a function of the user's selection.

30. The system of claim 29, wherein the central computer system also receives information from the remote computer system about the address associated with the user.

31. The system of claim 29, wherein the central computer system receives information from the remote computer system about the purported identity of the user when the user attempts to gain access to certain features of the central computer system.

32. The system of claim 31, wherein the information about the purported identity of the user is a user name and password.

33. The system of claim 29, wherein the central computer system comprises one or more servers connected to the internet.

34. The system of claim 29, wherein the remote computer system is a desk top computer, a personal computer, a tablet computer or a smart phone.

35. The system of claim 29, wherein the plurality of images of street scenes are selected by:
determining the geographical area of the neighbourhood as a function of the address associated with the user;
selecting a subset of images of street scenes from a larger set of images of street scenes located within the geographical area; and
selecting a subset of images of street scenes from a larger set of images of street scenes located outside of the geographical area.

36. The system of claim 29, wherein the selection of images is made as a function of the demographics of the user.

37. The system of claim 36, wherein the demographics of the user are stored in one or more of the memories of the central computer system and are retrieved in response to the central computer system receiving the information about the purported identity of the user.

38. The system of claim 36, wherein the demographics include the occupation of the user.

39. The system of claim 36, wherein the demographics include the age of the user.

40. The system of claim 36, wherein the demographics include the income of the user.

41. The system of claim 36, wherein the demographics include the marital status of the user.

42. The system of claim 36, wherein the demographics include the number of children of the user.

43. The system of claim 36, wherein the demographics include the employment status of the user.

44. The system of claim 29, wherein the images of street scenes located within the geographical area are selected to avoid images of retail shops having standard exteriors.

45. The system of claim 29, wherein images of street scenes located within the geographical area are selected to avoid images of national brand name businesses.

46. The system of claim 29, wherein the images of street scenes located within the geographical area are selected to avoid images of street scenes showing writing indicative of the location of the street scene.

47. The system of claim 29, wherein the presence of one or more businesses in the image of the street scene makes it more likely that it will be selected.

48. The system of claim 29, wherein the images selected have metadata associated therewith and the selection of the images is made as a function of such metadata.

49. The system of claim 48, wherein the metadata of the images are stored at the central computer system and the images themselves are stored in a third party computer system which is not controlled by the entity who controls the central computer system.

50. The system of claim 29, wherein the rating of confidence is determined as a function of the number of correct images selected.

51. The system of claim 50, wherein the rating of confidence is determined as function of other information received by the central computer system from the remote computer system relating to the manner in which the user made the selection.

52. The system of claim 50, wherein the other information includes the time taken by the user to select the images.

53. The system of claim 51, wherein the other information includes click stream data received by the central computer system from the remote computer system.

54. The system of claim 50, wherein the other information includes information received by the central computer system from the remote computer system concerning the dwell time between selections of images by the user.

55. The system of claim 29, wherein the images within the geographical area are selected as a function of the distance of the location of the street scene in the image from the address associated with the user.
